(19) United States
(12) Patent Application Publication
(10) Pub. No.: US 2022/0101509 A1
(43) Pub. Date: Mar. 31, 2022

(54) DETERIORATION DIAGNOSTIC DEVICE, DETERIORATION DIAGNOSTIC SYSTEM, DETERIORATION DIAGNOSTIC METHOD, AND RECORDING MEDIUM

(71) Applicant: Nec Corporation, Minato-ku, Tokyo (JP)

(72) Inventors: Nana JUMONJI, Tokyo (JP); Hidenori TSUKAHARA, Tokyo (JP)

(73) Assignee: NEC Corporation, Minato-ku, Tokyo (JP)

(21) Appl. No.: 17/426,127

(22) PCT Filed: Dec. 24, 2019
(86) PCT No.: PCT/JP2019/050653

§ 371 Date: Jul. 28, 2021

(30) Foreign Application Priority Data
Jan. 30, 2019 (JP) 2019-014330

(51) Int. Cl. G06T 7/00

(52) U.S. Cl. CPC G06T 7/0002; G06T 2207/30252

(57) ABSTRACT

A deterioration diagnostic device acquires captured images from an image capturing device, the image capturing device being provided on a moving body that travels on a road surface and capturing images of the road surface; extracts, from the acquired captured images, a captured image captured at night and captured in a state of the road surface being illuminated; and diagnostics whether the road surface has deteriorated, using the extracted captured image.

### TECHNICAL FIELD

The present invention relates to a deterioration diagnostic device, a deterioration diagnostic system, a deterioration diagnostic method, and a recording medium.

### BACKGROUND ART

Public facilities such as road surfaces and information signs installed on the roadside deteriorate over time. The government diagnoses the deterioration of public facilities that deteriorate over time and maintains the deteriorated public facilities. A large amount of effort is required in diagnosing the deterioration of such public facilities.

Patent Document 1 discloses a technique of an apparatus for analyzing cracking in pavements. Paragraph 0011 of Patent Document 1 describes to improve the accuracy of crack detection by irradiating a road surface with light of a vehicle and image capturing the road surface at night, at which time there is no influence of sunlight.

In addition, Patent Document 2 discloses a technique for early discovery of potholes in pavements. Paragraphs 0044 to 0045 of Patent Document 2 describe to carry out an investigation at night in an environment where illuminance is defined preliminarily, so that cracks can be clearly confirmed in evaluating aged deterioration of asphalt.

### PRIOR ART DOCUMENTS

### Patent Documents

[Patent Document 1] Japanese Unexamined Patent Application, First Publication No. 2018-21375

[Patent Document 2] Japanese Unexamined Patent Application, First Publication No. 2018-28486

### SUMMARY OF THE INVENTION

### Problem to be Solved by the Invention

In diagnosing such deterioration of a traveling path on which a moving body such as a vehicle travels, the presence or absence of deterioration needs to be determined with an even higher degree of accuracy.

It is thus an object of the present invention to provide a deterioration diagnostic device, a deterioration diagnostic system, a deterioration diagnostic method, and a recording medium for solving the problem mentioned above.

### Means for Solving the Problem

According to a first example aspect of the present invention, a deterioration diagnostic device includes: a captured image acquisition means for acquiring captured images from an image capturing device, the image capturing device being provided on a moving body that travels on a road surface and capturing images of the road surface; a captured image extraction means for extracting, from the acquired captured images, a captured image captured at night and captured in a state of the road surface being illuminated; and a deterioration diagnostic means for diagnosing whether the road surface has deteriorated, using the extracted captured image.

According to a second example aspect of the present invention, a deterioration diagnostic system includes: a captured image acquisition means for acquiring captured images from an image capturing device, the image capturing device being provided on a moving body that travels on a road surface and capturing images of the road surface; a captured image extraction means for extracting, from the acquired captured images, a captured image captured at night and captured in a state of the road surface being illuminated; and a deterioration diagnostic means for diagnosing whether the road surface has deteriorated, using the extracted captured image.

According to a third example aspect of the present invention, a deterioration diagnostic method includes: acquiring captured images from an image capturing device, the image capturing device being provided on a moving body that travels on a road surface and capturing images of the road surface; extracting, from the acquired captured images, a captured image captured at night and captured in a state of the road surface being illuminated; and diagnosing whether the road surface has deteriorated, using the extracted captured image.

According to a fourth example aspect of the present invention, a recording medium storing a program which causes a computer to execute: acquiring captured images from an image capturing device, the image capturing device being provided on a moving body that travels on a road surface and capturing images of the road surface; extracting, from the acquired captured images, a captured image captured at night and captured in a state of the road surface being illuminated; and diagnosing whether the road surface has deteriorated, using the extracted captured image.

### Effect of the Invention

According to an example embodiment of the present invention, it is possible to further improve the accuracy of determining whether or not a road surface has deteriorated.

### BRIEF DESCRIPTION OF THE DRAWINGS

FIG. 1 is a diagram showing a brief overview of a deterioration diagnostic system according to a first example embodiment of the present invention.

FIG. 2 is a hardware configuration diagram of a deterioration diagnostic device according to the first example embodiment of the present invention.

FIG. 3 is a first diagram showing function blocks of the deterioration diagnostic device according to the first example embodiment of the present invention.

FIG. 4 is a second diagram showing function blocks of the deterioration diagnostic device according to the first example embodiment of the present invention.

FIG. 5 is a diagram showing a hardware configuration of a drive recorder according to the first example embodiment of the present invention.

FIG. 6 is a function block diagram of a control device included in the drive recorder according to the first example embodiment of the present invention.

FIG. 7 is a first diagram showing a processing flow of the drive recorder according to the first example embodiment of the present invention.

FIG. 8 is a second diagram showing a processing flow of the drive recorder according to the first example embodiment of the present invention.

FIG. 9 is a first diagram showing a processing flow of the deterioration diagnostic device according to the first example embodiment of the present invention.

FIG. 10 is a second diagram showing function blocks of the control device according to the first example embodiment of the present invention.

FIG. 11 is a diagram showing a deterioration diagnostic device according to a second example embodiment of the present invention.

FIG. 12 is a diagram showing a processing flow of the deterioration diagnostic device according to the second example embodiment of the present invention.

### EXAMPLE EMBODIMENT

Hereinafter, a deterioration diagnostic device 1 according to an example embodiment of the present invention will be described, with reference to the drawings.

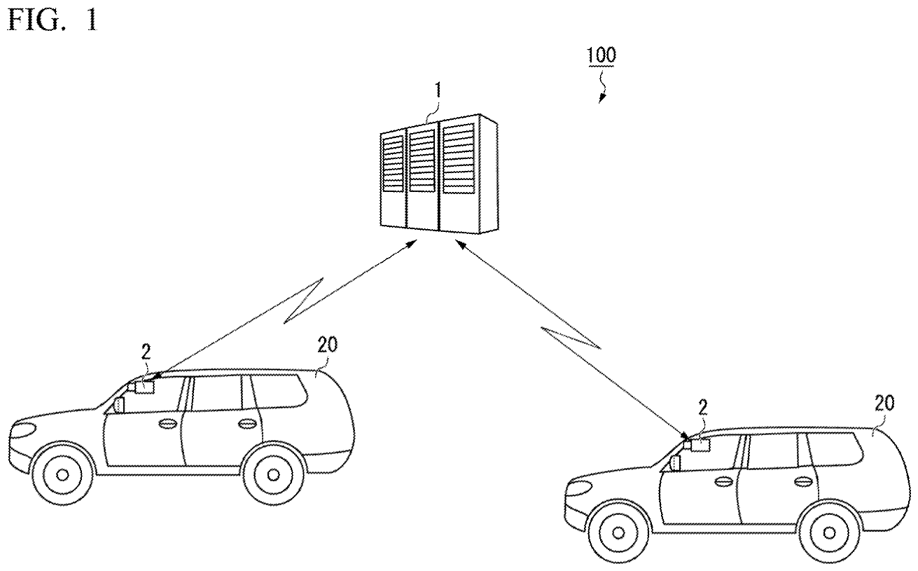

FIG. 1 is a diagram showing a brief overview of a deterioration diagnostic system 100 including the deterioration diagnostic device according to a first example embodiment.

As shown in FIG. 1, the deterioration diagnostic system 100 is configured such that the deterioration diagnostic device 1 and a drive recorder 2 are connected to each other via a wireless communication network or a wired communication network. The deterioration diagnostic device 1 is a computer server (a cloud server) that is installed, for example, by a business operator performing deterioration diagnosis and is connected to a communication network. The drive recorder 2 is provided in each of a plurality of moving bodies. In FIG. 1, an example is described in which the moving body is a vehicle 20. The moving body may include an autonomous vehicle. The drive recorder 2 has a camera and transmits captured images of the outside of the vehicle 20 to the deterioration diagnostic device 1.

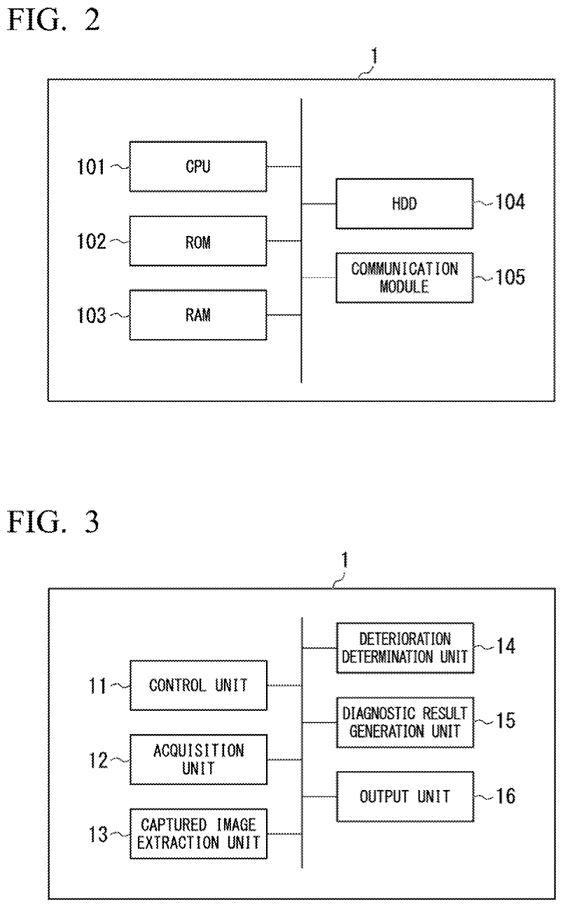

FIG. 2 is a hardware configuration diagram of the deterioration diagnostic device 1.

As shown in FIG. 2, the deterioration diagnostic device 1 is a computer that includes pieces of hardware such as a CPU (Central Processing Unit) 101, a ROM (Read Only Memory) 102, a RAM (Random Access Memory) 103, an HDD (Hard Disk Drive) 104, and a communication module 105.

FIG. 3 is a first diagram showing function blocks of the deterioration diagnostic device 1.

The deterioration diagnostic device 1 is activated when the power is turned on and executes a deterioration diagnostic program stored preliminarily. Thereby, the deterioration diagnostic device 1 exerts functions of a control unit (a control means) 11, an acquisition unit (an acquisition means) 12, a captured image extraction unit (a captured image extraction means) 13, a deterioration diagnostic unit (a deterioration diagnostic means) 14, a diagnostic result generation unit (a diagnostic result generation means) 15, and an output unit (an output means) 16.

The control unit 11 controls each functional unit of the deterioration diagnostic device 1.

The acquisition unit 12 acquires captured images captured by the drive recorder 2 mounted on the vehicle 20 and sensing information generated upon sensing performed by the vehicle 20 and other devices by means of various sensors. The sensing information includes position information of a vehicle (latitude, longitude), time, illuminance, illuminating device ON/OFF information, and so forth.

The captured image extraction unit 13 extracts, from captured images, captured images that are captured at night and are captured while the road surface is illuminated. That is to say, the captured image extraction unit 13 extracts captured images that are captured at night and are captured in a situation where the road surface is illuminated.

The deterioration diagnostic unit 14 diagnoses deterioration of the road surface, using images captured in a situation where the road surface is illuminated.

The diagnostic result generation unit 15 generates diagnostic result information on the basis of a result of the deterioration diagnosis.

The output unit 16 outputs the diagnostic result information and so forth to a predetermined output destination. An example of the output destination may be a computer used by government staff in charge of performing deterioration diagnosis, inspection, and maintenance of public facilities, for example.

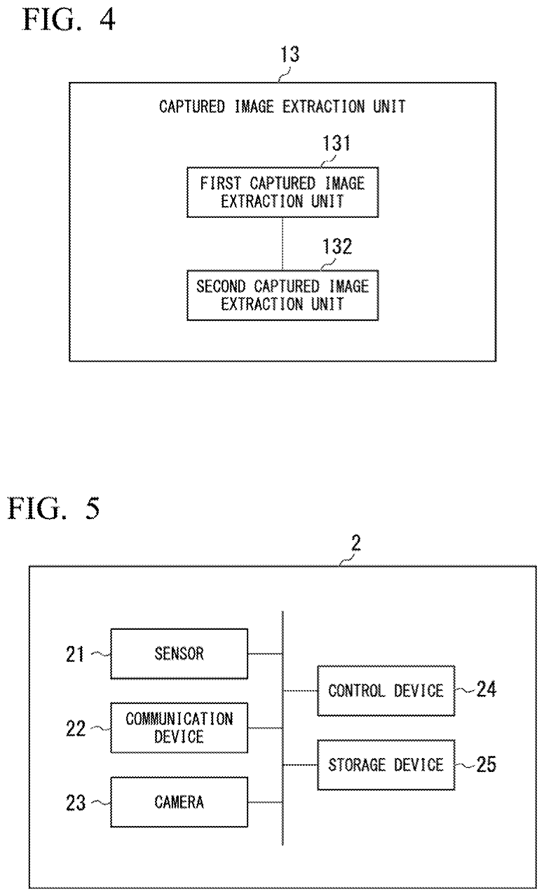

FIG. 4 is a second diagram showing function blocks of the deterioration diagnostic device 1.

The captured image extraction unit 13 mentioned above exerts the functions of a first captured image extraction unit (a first captured image extraction means) 131 and a second captured image extraction unit (a second captured image extraction means) 132.

The first captured image extraction unit 131 extracts, from the captured images received from the drive recorder 2, captured images captured at night. More specifically, the first captured image extraction unit 131 extracts captured images that are captured at night on the basis of a time of capturing. Alternatively, the first captured image extraction unit 131 extracts captured images that are captured at night on the basis of illuminance information. Or, the first captured image extraction unit 131 extracts captured images that are captured at night on the basis of the operating state of an illuminating device that is provided on the vehicle 20 and that illuminates the road surface.

The second captured image extraction unit 132 extracts, from the captured images that are captured at night, captured images that are captured in a situation where the road surface is illuminated.

FIG. 5 is a diagram showing a hardware configuration of the drive recorder 2.

The drive recorder 2 includes a sensor 21, a communication device 22, a camera 23, a control device 24, a storage device 25, and so forth.

The sensor 21 is a sensing device such as a GPS sensor. The sensor 21 may be a device that senses other information. For example, the sensor 21 may be a device that further detects an ON or OFF operating state of headlamps.

The communication device 22 is communicatively connected to the deterioration diagnostic device 1.

The camera 23 image captures the road surface, on which the vehicle 20 is traveling, in front of the vehicle 20, and generates moving images and still images thereof.

The control device 24 controls each function of the drive recorder 2.

The storage device 25 stores moving images, still images, and sensing information transmitted by the drive recorder 2. The drive recorder 2 is communicatively connected to the deterioration diagnostic device 1 via a base station or the like. The control device 24 of the drive recorder 2 is a computer including a CPU, a ROM, a RAM, and so forth.

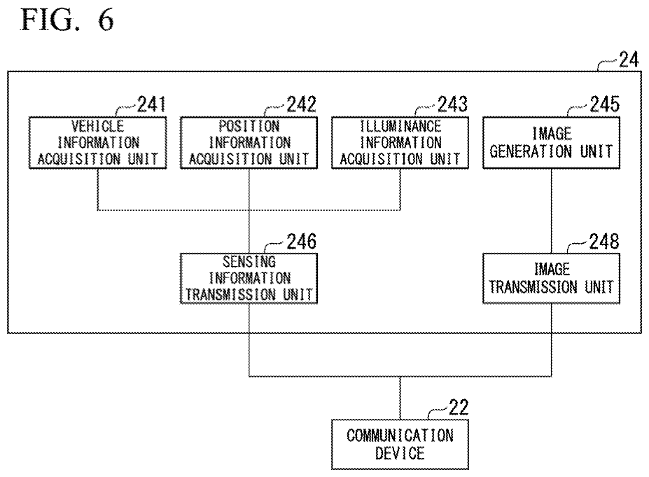

FIG. 6 is a first diagram showing function blocks of the control device included in the drive recorder.

The control device 24 executes a control program when the drive recorder 2 is activated. Thereby, the control device 24 exerts functions of a vehicle information acquisition unit (vehicle information acquisition means) 241, a position information acquisition unit (position information acquisition means) 242, an illuminance information acquisition unit (illuminance information acquisition means) 243, an image generation unit (image generation means) 245, a sensing information transmission unit (sensing information transmission means) 246, and an image transmission unit (image transmission means) 248.

The vehicle information acquisition unit 241 acquires vehicle information including information related to the vehicle 20 (driver ID, vehicle type, vehicle ID) recorded in a memory inserted in the drive recorder 2 and time information output by a timer. The vehicle information may include information indicating the operating state (ON or OFF) of the headlamps.

The position information acquisition unit 242 acquires, from the sensor 213 or the like, information such as position information (latitude information, longitude information) according to the time of the vehicle.

The illuminance information acquisition unit 243 acquires an illuminance obtained from an illuminometer provided in the vicinity of the windshield in the interior of the vehicle 20. The illuminometer is an aspect of the sensor 21, and is provided on the vehicle 20 to detect that the road surface is illuminated.

The image generation unit 245 acquires image data including at least one of moving images and still images from the camera 23 by image capturing with the camera 23, and generates and outputs captured images for uploading at predetermined intervals on the basis of the image data. As an example, the image generation unit 245 generates captured images at a predetermined generation speed.

The sensing information transmission unit 246 instructs the communication device 22 to transmit sensing information such as vehicle information and position information.

The image transmission unit 248 instructs the communication device 22 to transmit the captured images generated by the image generation unit 245.

In the deterioration diagnostic system 100 as described above, the deterioration diagnostic device 1 acquires captured images from the image capturing device that is provided on the moving body traveling on the road surface and that captures the image of the road surface, and extracts, from the captured images, captured images that are captured at night and that are captured in a situation where the road surface is illuminated. The deterioration diagnostic device 1 diagnoses deterioration of the road surface, using captured images captured in a situation where the road surface is illuminated. As a result, the deterioration diagnostic device 1 can improve the accuracy of determining the presence or absence of deterioration in the traveling path. Also, the deterioration diagnostic device 1 can determine the deterioration state of a large number of traveling paths, on the basis of captured images and sensing information acquired from a large number of vehicles 20.

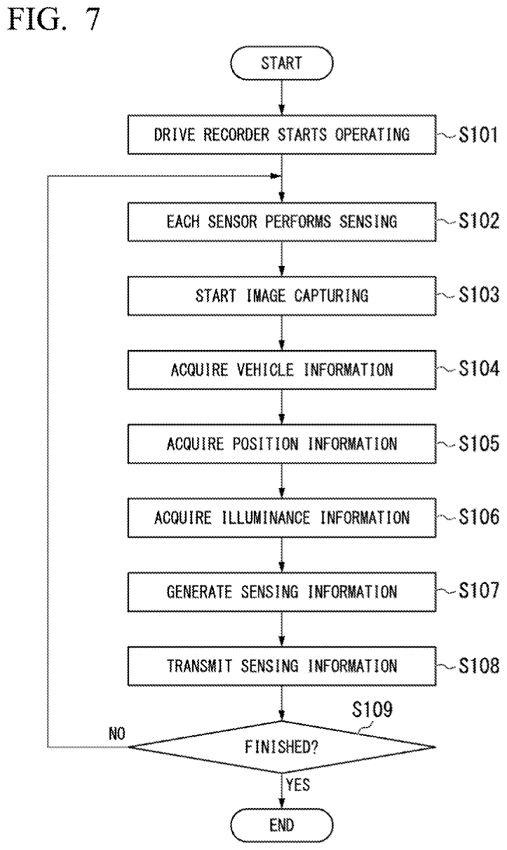

FIG. 7 is a first diagram showing a processing flow of the drive recorder 2.

Next, the processing flow of the drive recorder 2 will be described in a step-by-step manner.

First, the process of transmitting sensing information in the drive recorder 2 will be described.

When the electrical system of the vehicle is activated, the drive recorder 2 starts to operate (Step S101). The sensor 21 of the drive recorder 2 starts performing various types of sensing after the drive recorder 2 has been activated (Step S102). The camera 23 also starts image capturing (Step S103).

While the drive recorder 2 is operating, the vehicle information acquisition unit 241 of the control device 24 acquires vehicle information (driver ID, vehicle type, vehicle ID) (Step S104). The position information acquisition unit 242 acquires position information (latitude information, longitude information) from the sensor 21 at predetermined time intervals (Step S105). The illuminance information acquisition unit 243 acquires illuminance information (Step S106). The sensing information transmission unit 246 acquires the vehicle information, the position information (latitude information, longitude information), and the illuminance information, and generates sensing information including these pieces of information, the current time, the ID of the drive recorder 2, and so forth (Step S107). The sensing information transmission unit 246 requests the communication device 22 to transmit the sensing information to the deterioration diagnostic device 1. The communication device 22 transmits the sensing information to the deterioration diagnostic device 1 (Step S108). The control device 24 determines whether the processing is finished (Step S109), and repeats the processing from Step S102 until the processing is finished.

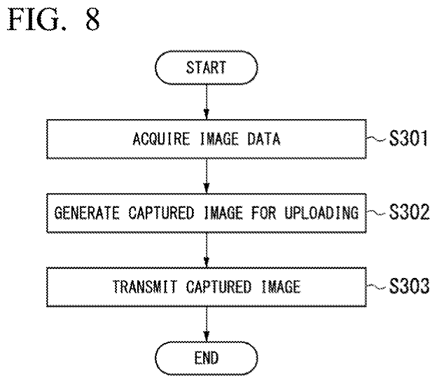

FIG. 8 is a second diagram showing a processing flow of the drive recorder 2. Next, the process of the drive recorder 2 transmitting captured images to the deterioration diagnostic device 1 will be described. The image generation unit 245 acquires image data including at least one of moving images and still images from the camera 23 by capturing with the camera 23 (Step S301). The image generation unit 145 generates captured images for uploading at predetermined intervals, on the basis of the acquired image data (Step S302). The image generation unit 145 instructs the image transmission unit 248 to transmit the captured images that have been generated. As attribute information, the image generation unit 145 may include, in the data indicated by the captured images, information such as generation time (or image capturing time), position information of a vehicle (latitude information, longitude information), drive recorder 2 ID (identifier), and driver ID. The image transmission unit 248 transmits the captured images to the deterioration diagnostic device 1 via the communication device 22 (Step S303).

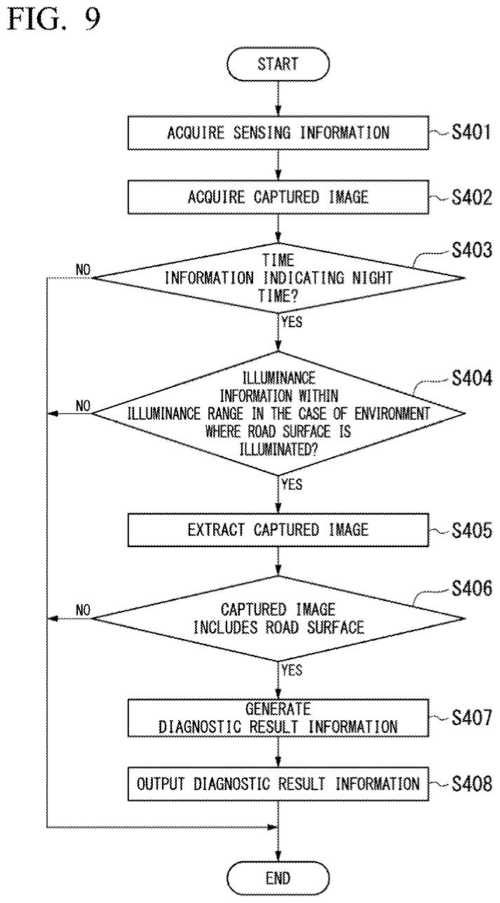

FIG. 9 is a first diagram showing a processing flow of the deterioration diagnostic device 1.

In the deterioration diagnostic device 1, the acquisition unit 12 acquires the sensing information transmitted by the communication device 22 of the vehicle 20 via the communication module 105 (Step S401). Also, the acquisition unit 12 acquires the captured images transmitted by the communication device 22 of the vehicle 20 (Step S402). The acquisition unit 12 outputs the captured image to the captured image extraction unit 13. Also, the acquisition unit 12 outputs the sensing information to the captured image extraction unit 13 and the deterioration diagnostic unit 14.

In the captured image extraction unit 13, the first captured image extraction unit 131 acquires illuminance information from the sensing information. The first captured image extraction unit 131 acquires time information included in the sensing information. The first captured image extraction unit 131 determines whether the time indicated by the time information is a time indicating a night time (Step S403). If the time indicated by the time information is a time indicating a night time, the first captured image extraction unit 131 instructs the second captured image extraction unit 132 to start processing. The night time may be the period from sunset to sunrise. Sunset may be a time at which the upper edge of the sun touches the western horizon. Sunrise may be a time at which the upper edge of the sun touches the eastern horizon.

If the time indicated by the time information is a time indicating a night time, the second captured image extraction unit 132 acquires illuminance information included in the sensing information. The second captured image extraction unit 132 determines whether the illuminance indicated by the illuminance information is included in an illuminance range in the case of an environment where the road surface is illuminated (Step S404). This determination is one aspect of determining whether or not the illuminance condition required for deterioration diagnosis is satisfied. If the illuminance indicated by the illuminance information is included in the illuminance range in the case of an environment where the road surface is illuminated (if the illuminance is greater than or equal to a predetermined value), the second captured image extraction unit 132 extracts captured images that are captured at that time (Step S405). That is to say, if the illuminance indicated by the illuminance information is included in the illuminance range in the case of an environment where the road surface is illuminated, the second captured image extraction unit 132 extracts captured images that are associated with the illuminance information (sensing information).

The second captured image extraction unit 132 may not use time information in determining whether or not the illuminance condition required for deterioration diagnosis is satisfied, and may perform the process of determining whether the illuminance indicated by the illuminance information acquired from the sensing information is included in the illuminance range in the case of an environment where the road surface is illuminated. The captured image extraction unit 13 similarly extracts captured images when the illuminance information is included in the range.

Alternatively, the second captured image extraction unit 132 may use information on the operating state of the illuminating device that illuminates the road surface in determining whether or not the illuminance condition required for deterioration diagnosis is satisfied. For example, a device that acquires vehicle information including the ON/OFF state of the headlamps directly transmits, to the deterioration diagnostic device 1, information indicating the headlamps of the vehicle 20, which is one aspect of the illuminating device, as being ON. Alternatively, the drive recorder 2 acquires, from the sensor detecting this ON/OFF, information indicating the headlamps of the vehicle 20, which is one aspect of the illuminating device, as being ON, and the drive recorder 2 may store it in the vehicle information to be transmitted to the deterioration diagnostic device 1. In such a case, the second captured image extraction unit 132 of the deterioration diagnostic device 1 detects that the headlamps are ON, on the basis of the vehicle information. Upon detecting the headlamps as being ON, the second captured image extraction unit 132 extracts, from the captured images acquired in Step S402, captured images including time information that either coincides with the time information included in the vehicle information or that falls in a predetermined range of time before and after the time. As an operating state of the illuminating device when extracting captured images captured at night, the headlamps being ON may be used as a condition, and also/or, the high beam of the headlamps being ON or a fog lamp being ON may be used as a condition. In such a case, the vehicle information includes high-beam ON/OFF information or fog-lamp ON/OFF information.

The second captured image extraction unit 132 may use the operating state of street lights to determine whether or not the illuminance condition required for deterioration diagnosis is satisfied. In such a case, the second captured image extraction unit 132 detects the operating state of street lights from information received from another device or from captured images, to thereby determine the operating state of the street lights. For example, the deterioration diagnostic device 1 receives street light management information including the operating state of the street lights from a street light management server that is communicatively connected. The street light management information includes at least one of the position information and the current operating state (light-ON, light-OFF) of each street light. The second captured image extraction unit 132 acquires at least one of the position information and the current operating state (light-ON, light-OFF) of each street light, from the street light management information. Based on the position information of each street light, if a street light is present within a predetermined range on the basis of the current position of the vehicle 20 (such as a range of 10 meter radius), the second captured image extraction unit 132 acquires the operating status of the street light. If the operating state of the street light indicates the light-ON state, the second captured image extraction unit 132 extracts captured images acquired in the vicinity thereof, from the captured images acquired in Step S402. Or in the case of detecting the operating state of a street light from captured images, the second captured image extraction unit 132 detecting, by means of image analysis, the light-ON or the light-OFF of a street light shown in the captured images, and, by using the results, similarly extracts, from the captured images acquired in Step S402, captured images acquired in the vicinity of a street light that is in the light-ON.

When determining whether or not the illuminance condition required for deterioration diagnosis is satisfied, the second captured image extraction unit 132 may use the brightness of captured images for the determination. For example, the second captured image extraction unit 132 determines whether the brightness in captured images is included in a range of brightness in the case of an environment where the road surface is illuminated. The captured image extraction unit 13 similarly extracts captured images when the brightness in the captured images is included in the range.

Furthermore, the captured image extraction unit 13 may determine whether the environment is suitable for deterioration diagnosis, on the basis of weather. In such a case, the captured image extraction unit 13 transmits a weather information distribution request to a weather information distribution server that is communicatively connected. The distribution request includes the position information of the vehicle 20 detected by the captured image extraction unit 13. Then, the weather information distribution server transmits weather information to the deterioration diagnostic device 1 on the basis of the request. The captured image extraction unit 13 acquires the weather information that the deterioration diagnostic device 1 received from the weather information distribution server. The captured image extraction unit 13 determines to extract captured images if the weather information indicates sunny or cloudy. If the weather information indicates rainfall or snowfall, the captured image extraction unit 13 determines to stop extraction of captured images.

Then, the captured image extraction unit 13 outputs the extracted captured images to the deterioration diagnostic unit 14. The deterioration diagnostic unit 14 diagnoses deterioration of the road surface, using the captured images received from the captured image extraction unit 13. Specifically, the deterioration diagnostic unit 14 determines whether or not the captured images received from the captured image extraction unit 13 include a road surface, which is an example of an inspection target (Step S406). The deterioration diagnostic unit 14 determines whether captured images include a road surface, using image pattern matching, machine learning processing, or AI (Artificial Intelligence) analysis. A known technique may be used for recognizing a road surface in captured images. If a road surface is determined as being included in the captured image, the deterioration diagnostic unit 14 starts diagnosing deterioration of the road surface.

A specific example of deterioration diagnosis will be described.

When performing a deterioration diagnosis based on a crack in a road surface shown in captured images, the deterioration diagnostic unit 14 identifies the size of the crack (the length, the width, or the proportion of the range including the crack in captured images) from the captured images, and calculates the degree of deterioration on the basis of the size of the crack. The larger the crack, the higher the degree of deterioration.

Also, when performing a deterioration diagnosis based on a hole in a road surface shown in captured images, the deterioration diagnostic unit 14 identifies the size of the hole (diameter, width) from the captured images, and calculates the degree of deterioration on the basis of the size of the hole. The larger the hole, the higher the degree of deterioration.

Also, when performing a deterioration diagnosis based on ruts in a road surface shown in captured images, the deterioration diagnostic unit 14 identifies the size (length, width) of the ruts from the captured images, and calculates the degree of deterioration on the basis of the size of the ruts. The larger the ruts the higher the degree of deterioration.

When the degree of deterioration is greater than or equal to a threshold value, the deterioration diagnostic unit 14 may determine deterioration as having occurred. If deterioration is determined as having occurred, the deterioration diagnostic unit 14 outputs the type of the deterioration (crack, hole, ruts) and the position of the deterioration to the diagnostic result generation unit 15. The diagnostic result generation unit 15 generates diagnostic result information including at least the deterioration type (crack, hole, ruts) and the deterioration position (Step S407). The diagnostic result information may be, for example, map data that displays on a map the position of the road surface deterioration and an icon image indicating the deterioration type at the position. The diagnostic result generation unit 15 outputs the diagnostic result information to the output unit 16 (Step S408). The output unit 16 outputs the diagnostic result information to a predetermined device. Alternatively, the output unit 16 may record the diagnostic result information in a predetermined storage device. The deterioration diagnostic device 1 repeats the processing described above.

According to the above processing, the deterioration diagnostic device 1 can perform a deterioration diagnosis on a road surface, using captured images that satisfy the illuminance condition required for deterioration diagnosis. For example, the deterioration diagnostic device 1 can improve the accuracy of determining the presence or absence of deterioration in a traveling path by not using captured images for deterioration diagnosis that do not satisfy the illuminance condition required for deterioration diagnosis due to excessively low illuminance.

When using captured images of a road surface during the hours of the day where the irradiation intensity of sunlight is high, an electrical cable or the like may cast a shadow on the road surface, creating a possibility of the deterioration diagnostic device 1 recognizing the thin shadow as a crack in error. According to the processing described above, the deterioration diagnostic device 1 can reduce erroneous deterioration diagnosis caused by a shadow shown in captured images, using captured images that are captured at night.

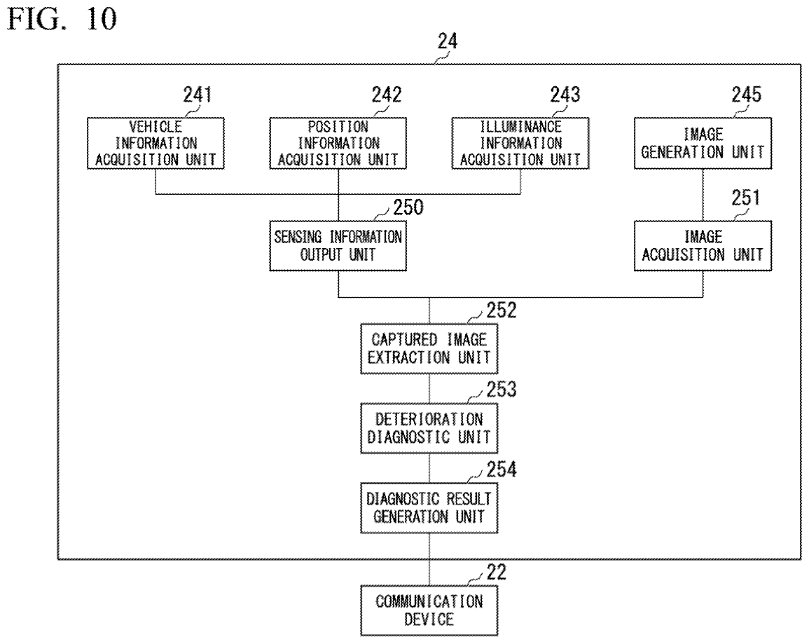

FIG. 10 is a second diagram showing function blocks of the control device included in the drive recorder 2.

In the above description there has been described the case where the deterioration diagnostic device 1 performs the process of extracting captured images, the process of performing deterioration diagnosis, and the process of generating diagnostic result information; however, these processes may be performed by the drive recorder 2. In such a case, the drive recorder 2 serves as the deterioration diagnostic device 1. When the drive recorder 2 functions as the deterioration diagnostic device 1, the control device 24 of the drive recorder 2 exerts functions of a sensing information output unit (a sensing information output means) 250, an image acquisition unit (an image acquisition means) 251, a captured image extraction unit (a captured image extraction means) 252, a deterioration diagnostic unit (a deterioration diagnostic means) 253, and a diagnostic result generation unit (a diagnostic result generation means) 254. In the control device 24 of the drive recorder 2, the sensing information output unit 250 outputs sensing information to the captured image extraction unit 252, and the image acquisition unit 251 outputs captured images to the captured image extraction unit 252. As with the deterioration diagnostic device 1 described with reference to FIG. 1 to FIG. 9, the captured image extraction unit 252 of the control device 24 performs the process of extracting captured images; the deterioration diagnostic unit 253 performs the process of deterioration diagnosis in a similar manner; and the diagnostic result generation unit 254 performs the process of generating diagnosis result information in a similar manner. The diagnostic result generation unit 254 transmits the generated diagnostic result information to a predetermined external device, using the communication device 22.

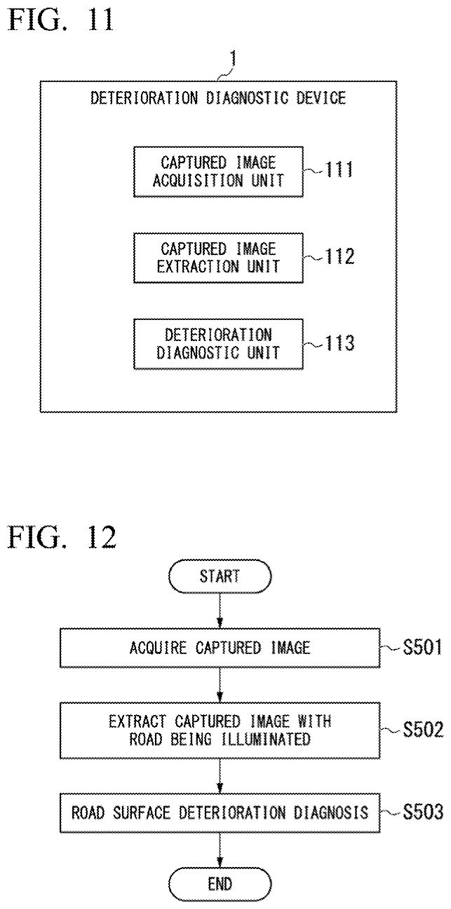

FIG. 11 is a diagram showing a deterioration diagnostic device 1 according to a second example embodiment.

FIG. 12 is a diagram showing a processing flow by the deterioration diagnostic device 1 according to a second example embodiment.

As shown in FIG. 11, the deterioration diagnostic device 1 exerts the functions of at least the captured image acquisition unit 111, the captured image extraction unit 112, and the deterioration diagnostic unit 113.

The captured image acquisition unit 111 acquires captured images from the camera 23 that is provided on a moving body traveling on a road surface and that captures the image of the road surface (Step S501).

The captured image extraction unit 112 extracts, from captured images, captured images that are captured at night and are captured in a situation where the road surface is illuminated (Step S502).

The deterioration diagnostic unit 113 diagnoses deterioration of the road surface, using the captured images captured in a situation where the road surface is illuminated (Step S503).

The deterioration diagnostic device 1, the control device 24 of the drive recorder 2 described above, and a terminal device have a built-in computer system. The process of each processing described above is stored in a computer-readable recording medium in a form of a program, and the processing mentioned above is performed by a computer reading and executing the program.

The program mentioned above may be a program for realizing some of the functions described above. Furthermore, it may be a so-called difference file (a difference program) which can realize the functions described above in combination with a program already recorded in the computer system.

This application is based upon and claims the benefit of priority from Japanese patent application No. 2019-014330, filed, Jan. 30, 2019, the disclosure of which is incorporated herein in its entirety by reference.

### INDUSTRIAL APPLICABILITY

The present invention may be applied to a deterioration diagnostic device, a deterioration diagnostic system, a deterioration diagnostic method, and a recording medium.

### REFERENCE SYMBOLS

1 Deterioration diagnostic device

2 Drive recorder

11 Control unit

12 Acquisition unit

14 Deterioration diagnostic unit

13 Captured image extraction unit

15 Diagnostic result generation unit

16 Output unit

21 Sensor

22 Communication device

23 Camera

24 Control device

25 Storage device

131 First captured image extraction unit

132 Second captured image extraction unit

241 Vehicle information acquisition unit

242 Position information acquisition unit

243 Illuminance information acquisition unit

245 Image generation unit

246 Sensing information transmission unit

248 Image transmission unit

250 Sensing information output unit

251 Image acquisition unit

252 Captured image extraction unit

253 Deterioration diagnostic unit

254 Diagnostic result generation unit

What is claimed is:

1. A deterioration diagnostic device comprising:
at least one memory configured to store instructions; and
at least one processor configured to execute the instructions to:
acquire images from an image capturing device, the image capturing device being provided on a moving body that travels on a road surface and capturing images of the road surface;
extract, from the acquired images, an image based on a time of capturing; and
diagnose whether the road surface has deteriorated, using the extracted image.

2-7. (canceled)

8. A deterioration diagnostic system comprising:
at least one memory configured to store instructions; and
at least one processor configured to execute the instructions to:
acquire images from an image capturing device, the image capturing device being provided on a moving body that travels on a road surface and capturing images of the road surface;
extract, from the acquired images, an image based on a time of capturing; and
diagnose whether the road surface has deteriorated, using the extracted image.

9. A deterioration diagnostic method comprising:
acquiring images from an image capturing device, the image capturing device being provided on a moving body that travels on a road surface and capturing images of the road surface;
extracting, from the acquired images, an image based on a time of capturing; and
diagnosing whether the road surface has deteriorated, using the extracted captured image.

10. (canceled)

11. The deterioration diagnostic device according to claim 1, wherein extracting the image comprises extracting an image captured at a time which indicates a predetermined situation.

12. The deterioration diagnostic device according to claim 1, wherein diagnosing whether the road surface has deteriorated comprises determining whether the extracted image includes an image of the road surface, and diagnosing whether the road surface has deteriorated when it is determined that the extracted image includes the image of the road surface.

13. The deterioration diagnostic device according to claim 1, wherein extracting the image comprises extracting an image that satisfies an illuminance condition.
